(19) United States
(12) Patent Application Publication
(10) Pub. No.: US 2023/0151766 A1
(43) Pub. Date: May 18, 2023

(54) INTEGRATED GASIFICATION COMBINED CYCLE AND OPERATION METHOD THEREOF

(71) Applicant: MITSUBISHI HEAVY INDUSTRIES, LTD., Tokyo (JP)

(72) Inventors: Osamu Shinada, Kanagawa (JP); Tomoya Hayashi, Kanagawa (JP)

(73) Assignee: MITSUBISHI HEAVY INDUSTRIES, LTD., Tokyo (JP)

(21) Appl. No.: 17/914,841

(22) PCT Filed: Mar. 19, 2021
(86) PCT No.: PCT/JP2021/011303

§ 371 Date: Sep. 27, 2022

(30) Foreign Application Priority Data
Mar. 31, 2020 (JP) 2020-063372

(51) Int. Cl. F02C 3/28; C10J 3/46; F02C 6/00; F02C 7/042; F23K 3/02

(52) U.S. Cl. CPC F02C 3/28; C10J 3/46; F02C 6/00; F02C 7/042; F23K 3/02

(57) ABSTRACT

A pulverizer that pulverizes coal into pulverized coal; a gasifier that gasifies pulverized coal pulverized by the pulverizer; a combustor that combusts a gasified gas gasified by the gasifier; a compressor that supplies compressed air to the combustor; a gas turbine driven by a combustion gas generated by the combustor; a generator driven by the gas turbine to generate power; a flue gas supply channel that guides a part of a flue gas from the gas turbine to the pulverizer; an IGV that adjusts a flow rate of air supplied from the compressor to the combustor; and a controller that applies an air flow-rate reduction operation to control the IGV so that the flow rate of air is smaller than a set air flow rate determined from a set combustion temperature of the combustor.

### TECHNICAL FIELD

The present disclosure relates to an integrated gasification combined cycle and an operation method thereof.

### BACKGROUND ART

Conventionally, as integrated gasification combined cycles, integrated coal gasification combined cycles (IGCC) are known that partially combust and gasify coal, which is carbonaceous feedstock, in a gasifier, drive a gas turbine by using the gasified combustible gas, and generate power by using exhaust heat from the gas turbine.

In a gasification unit that supplies coal to a gasifier by a dry coaling scheme, coal is pulverized into pulverized coal by a coal pulverizer, and the pulverized coal is dried by a dry gas for the purpose of preventing closure when carrying pulverized coal from a pulverized coal supply unit to the gasifier. Herein, a gas having a low oxygen concentration is required to be used for drying pulverized coal in terms of prevention of spontaneous combustion of pulverized coal in particular in a dust precipitator, and a flue gas from a gas turbine is used (see Patent Literatures 1 and 2).

Patent Literature 1 intends to optimize the plant efficiency by extracting a flue gas from two positions in upstream and downstream of a heat recovery steam generator (HRSG) and adjusting the flue gas to have a temperature and a flow rate required for drying pulverized coal.

In Patent Literature 2, when the oxygen concentration in a flue gas from a gas turbine temporarily increases above a specified value, such as when the gas turbine is started up causing a lower load than the rated load, an auxiliary combustion burner installed in a heat recovery steam generator is started to reduce the oxygen concentration.

### Citation List

### Patent Literature

PTL 1 Japanese Patent Application Laid-Open No. S61-175241
PTL 2 Japanese Patent No. 4939511

### SUMMARY OF INVENTION

### Technical Problem

Although reducing the oxygen concentration in a flue gas from a gas turbine by starting up an auxiliary combustion burner as disclosed in Patent Literature 2 may be one countermeasure, this requires a fuel supply unit used for the auxiliary combustion burner, which is a factor of leading to an increase in the number of devices (increase in cost of equipment), an increase in fuel cost due to a need of supplying fuel for the auxiliary combustion burner, and a reduction in the plant efficiency.

The present disclosure has been made in view of such circumstances and intends to provide an integrated gasification combined cycle and an operation method thereof that can reduce the possibility of spontaneous combustion of pulverized fuel pulverized by a pulverizer, without using an auxiliary combustion burner.

### Solution to Problem

To solve the problem described above, an integrated gasification combined cycle of the present disclosure includes: a pulverizer configured to pulverize carbonaceous feedstock into pulverized fuel; a gasifier configured to gasify pulverized fuel pulverized by the pulverizer; a combustor configured to combust a gasified gas gasified by the gasifier; a compressor configured to supply compressed air to the combustor; a gas turbine driven by a combustion gas generated by the combustor; a generator driven by the gas turbine to generate power; a flue gas supply channel configured to guide a part of a flue gas from the gas turbine to the pulverizer, a supply air flow-rate adjustment unit configured to adjust a flow rate of air supplied from the compressor to the combustor; and a controller configured to apply an air flow-rate reduction operation to control the supply air flow-rate adjustment unit so that the flow rate of air is smaller than a set air flow rate calculated from a set combustion temperature of the combustor.

An operation method of an integrated gasification combined cycle of the present disclosure is an operation method of an integrated gasification combined cycle including a pulverizer configured to pulverize carbonaceous feedstock into pulverized fuel, a gasifier configured to gasify pulverized fuel pulverized by the pulverizer, a combustor configured to combust a gasified gas gasified by the gasifier, a compressor configured to supply compressed air to the combustor, a gas turbine driven by a combustion gas generated by the combustor, a generator driven by the gas turbine to generate power, a flue gas supply channel configured to guide a part of a flue gas from the gas turbine to the pulverizer, and a supply air flow-rate adjustment unit configured to adjust a flow rate of air supplied from the compressor to the combustor, and the operation method includes: applying an air flow-rate reduction operation to control the supply air flow-rate adjustment unit so that the flow rate of air is smaller than a set air flow rate calculated from a set combustion temperature of the combustor.

### Advantageous Effects of Invention

Since the flow rate of air supplied to a combustor of a gas turbine is reduced, the possibility of spontaneous combustion of pulverized fuel pulverized by a pulverizer can be reduced without use of an auxiliary combustion burner.

### BRIEF DESCRIPTION OF DRAWINGS

FIG. 1 is a schematic configuration diagram illustrating an integrated gasification combined cycle according to one embodiment of the present disclosure.

FIG. 2 is a graph illustrating an oxygen concentration adjustment method for a drying gas.

FIG. 3 is a graph illustrating an oxygen concentration adjustment method for a drying gas.

FIG. 4 is a schematic configuration diagram illustrating Modified example 2.

FIG. 5 is a schematic configuration diagram illustrating Modified example 3.

FIG. 6 is a schematic configuration diagram illustrating Modified example 4.

FIG. 7 is a schematic configuration diagram illustrating Modified example 5.

FIG. 8 is a schematic configuration diagram illustrating Modified example 6.

FIG. 9 is a schematic configuration diagram illustrating Modified example 7.

FIG. 10 is a schematic configuration diagram illustrating Modified example 8.

### DESCRIPTION OF EMBODIMENTS

One embodiment according to the present disclosure will be described below with reference to the drawings.

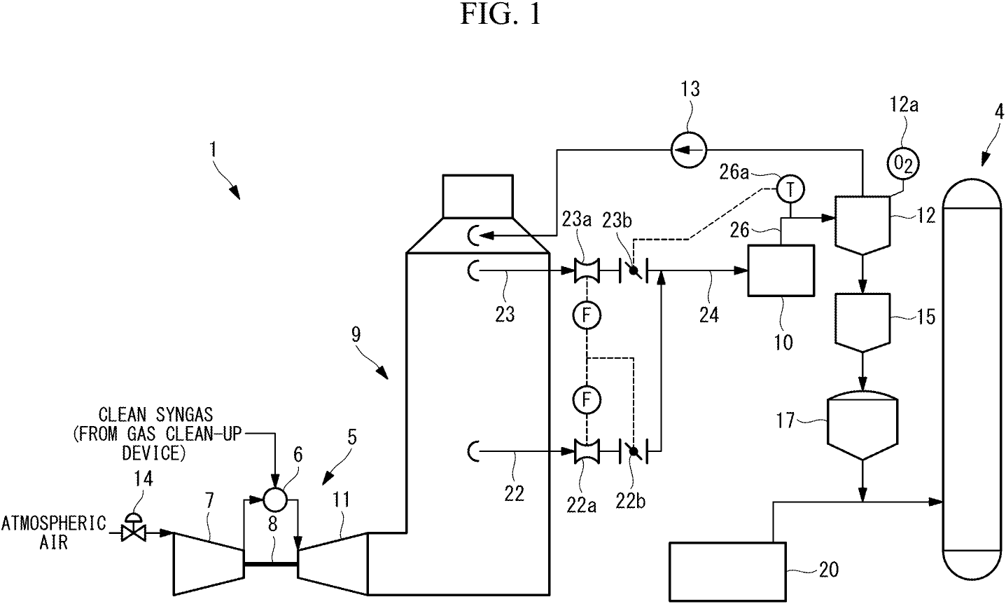

FIG. 1 illustrates an integrated gasification combined cycle 1 according to the present embodiment. The integrated gasification combined cycle (hereafter, referred to as “IGCC”) 1 employs an air combustion scheme to generate a combustible gas gasified from coal by a gasifier 4 with use of air or oxygen as an oxygen containing gas. The IGCC 1 supplies a combustor 6 of a gas turbine 5 with a clean syngas (a gasified gas, a coal gas) as a fuel gas obtained after a raw syngas (a gasified gas, a coal gas) gasified by the gasifier 4 has been purified by a gas clean-up device (not illustrated).

The gas turbine 5 has a combustor 6, a turbine 11 rotated and driven in response to supply of a combustion gas from the combustor 6, and a compressor 7 having a rotation shaft 8 common to the turbine 11. An inlet guide vane (IGV: a supply air flow-rate adjustment unit) 14 that adjusts the flow rate of suction air from the atmospheric air is provided upstream of the compressor 7. The opening of the IGV 14 is controlled by a controller (not illustrated).

In the IGCC 1, a part of a flue gas passing through a heat recovery steam generator (HRSG) 9 is introduced as a drying gas, this drying gas is supplied to the inlet of a coal pulverizer (a pulverizer) 10, and coal to be used as feedstock is supplied to the inlet of the coal pulverizer 10. The coal pulverizer 10 heats coal supplied by the drying gas and pulverizes the coal into fine particles while removing moisture from the coal to produce pulverized coal (pulverized fuel).

The pulverized coal produced by the coal pulverizer 10 is carried to a dust precipitator 12 by a drying gas. Inside the dust precipitator 12, a gas component such as the drying gas and pulverized coal (a particle component) are separated from each other, and the gas component is discharged from the outlet of the heat recovery steam generator 9 via an induced draft fan 13. The dust precipitator 12 is provided with an oxygen concentration sensor 12a that measures the oxygen concentration inside the dust precipitator 12.

The pulverized coal of the particle component separated by the dust precipitator 12 drops by the gravity and is supplied to a hopper 17 via a bin 15.

The pulverized coal recovered inside the hopper 17 is carried into the gasifier 4 by a nitrogen gas (a carrier gas) introduced for pressurized carriage from an air separation unit (ASU) 20.

The gasifier 4 is supplied with pulverized coal and char as feedstock for a raw syngas. In the gasifier 4, compressed air supplied from the compressor 7 of the gas turbine 5 and oxygen supplied from the air separation unit 20 or any one thereof is used as an oxygen containing gas, and a raw syngas gasified from the pulverized coal and char is produced. The raw syngas generated by the gasifier 4 is guided to a gas clean-up unit (not illustrated).

A clean syngas from which sulfur substances or the like have been removed by the gas clean-up unit is supplied to the combustor 6 of the gas turbine 5 and combusted together with the compressed air guided from the compressor 7, and thereby a high-temperature and high-pressure combustion gas is generated. The combustion gas is guided to the turbine 11 to rotate and drive the turbine 11. The rotated and driven turbine 11 drives a gas turbine generator (not illustrated) coupled to the rotation shaft of the turbine 11 to generate power.

A high-temperature flue gas discharged from the turbine 11 is supplied to the heat recovery steam generator 9 and used as a heat source for generating steam. The steam generated by the heat recovery steam generator 9 is supplied to a steam turbine or the like (not illustrated) used for power generation. The flue gas used for steam generation in the heat recovery steam generator 9 is discharged to the atmospheric air after necessary treatment is applied thereto by a SCR (Selective Catalytic NOx Reduction) system or the like.

A part of the flue gas used for steam generation in the heat recovery steam generator 9 is extracted as a drying gas for the coal pulverizer 10. For this drying gas, a flue gas after subjected to treatment such as denitration is used. Specifically, a high-temperature flue gas extraction channel (a flue gas supply channel) 22 connected around directly downstream of a SCR system (not illustrated) of the heat recovery steam generator 9 and a low-temperature flue gas extraction channel (a flue gas supply channel) 23 connected downstream from the high-temperature flue gas extraction channel 22 are provided. The high-temperature flue gas extraction channel 22 and the low-temperature flue gas extraction channel 23 merge into a merged flue gas extraction channel 24 downstream. The downstream of the merged flue gas extraction channel 24 is connected to the coal pulverizer 10.

The high-temperature flue gas extraction channel 22 and the low-temperature flue gas extraction channel 23 are provided with flowmeters 22a, 23a and temperature adjusting dampers 22b, 23b, respectively. The measured value of each flowmeter 22a, 23a is transmitted to the controller. The controller controls the opening of each damper 22b, 23b based on the measured value of each flowmeter 22a, 23a and a measured value of a temperature sensor 26a provided to a pulverized coal discharge channel 26 of the coal pulverizer 10. Accordingly, the temperature and the flow rate of the drying gas supplied to the coal pulverizer 10 are adjusted.

The controller is formed of a central processing unit (CPU), a random access memory (RAM), a read only memory (ROM), a computer readable storage medium, and the like, for example. Further, a series of processes for implementing various functions are stored in a storage medium or the like in a form of a program as an example, and various functions are implemented when the CPU loads the program into the RAM or the like and performs processing or calculation process on information. Note that the program may be applied in a form in which the program is installed in advance in the ROM or another storage medium, a form in which the program is provided in a state of being stored in a computer readable storage medium, a form in which the program is delivered via a wired or wireless communication scheme, or the like. The computer readable storage medium may be a magnetic disk, a magneto-optical disk, a CD-ROM, a DVD-ROM, a semiconductor memory, or the like.

### Drying Gas Oxygen Concentration Adjustment 1

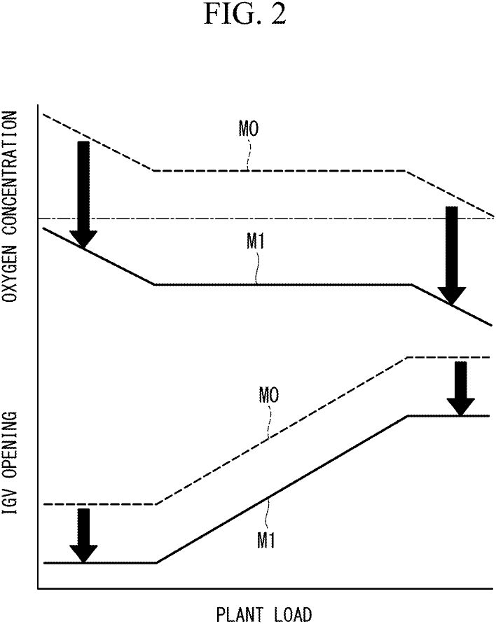

Next, an adjustment method of the oxygen concentration in a drying gas supplied to the coal pulverizer 10 will be described with reference to FIG. 2.

In FIG. 2, the horizontal axis represents the plant load, the vertical axis of the lower graph represents the IGV opening to adjust the flow rate of air supplied to the gas turbine 5, and the vertical axis of the upper graph represents the oxygen concentration in a drying gas supplied to the coal pulverizer 10. The line indicated by the dashed line represents a set air flow-rate operation M0, which represents a set IGV opening of the IGV 14 calculated from a set combustion temperature and a fuel gas composition of the combustor 6 (amount of heat generation) and a set oxygen concentration determined from the set IGV opening. The oxygen concentration in the drying gas corresponds to the oxygen concentration measured by the oxygen concentration sensor 12a of the dust precipitator 12. In general, when the IGCC 1 is designed, a set combustion temperature of the combustor 6 is determined in accordance with a plant load, a required air flow rate is calculated from the composition of a clean syngas in accordance with the set combustion temperature, and a set IGV opening is determined as indicated by the dashed line. The set IGV opening is programmed in the controller.

In contrast, in the present embodiment, the IGV opening is controlled as indicated by the solid line. Specifically, the IGV opening is controlled so that the air flow rate is less than the air flow rate corresponding to the set oxygen concentration indicated by the dashed line (air flow-rate reduction operation M1). Accordingly, the IGV opening can be controlled to be lower than the limit oxygen concentration (for example, 13% by volume) indicated by the dot and dash line in FIG. 2 that may cause spontaneous combustion of pulverized coal. In other words, when the plant load exceeds the limit oxygen concentration for the overall plant load, the IGV 14 is controlled so that the IGV opening is less than the set IGV opening indicated by the dashed line for the overall plant load as illustrated in FIG. 2.

As discussed above, by controlling the IGV opening to apply the air flow-rate reduction operation M1, it is possible to reduce the oxygen concentration in the drying gas, that is, the oxygen concentration in the coal pulverizer 10 or the dust precipitator 12. Therefore, the possibility of spontaneous combustion of pulverized coal pulverized by the coal pulverizer 10 can be reduced without use of an auxiliary combustion burner as with Patent Literature 2.

### Drying Gas Oxygen Concentration Adjustment 2

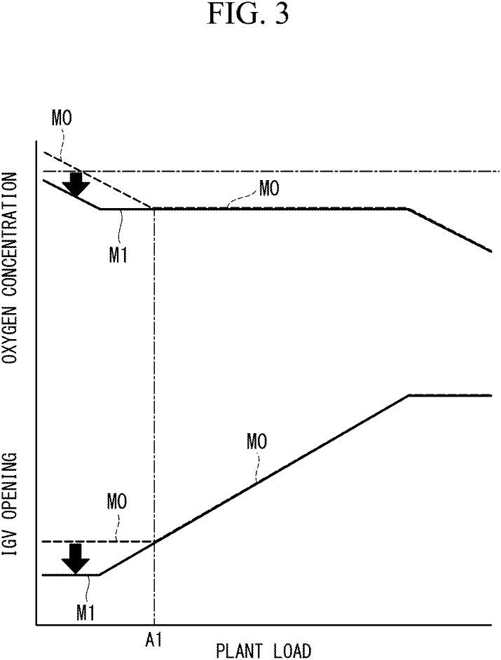

It is also possible to perform control as with FIG. 3. That is, the oxygen concentration in the flue gas flowing in the heat recovery steam generator 9 increases at a low load, such as at startup of the IGCC 1. In such a case, as illustrated in FIG. 3, only when the load is low, the IGV is controlled to be lower than the set IGV opening indicated by the dashed line to apply the air flow-rate reduction operation M1. The set value A1 for a low load that triggers the air flow-rate reduction operation M1 is 50% or less or 40% or less of the rated value.

On the other hand, the set air flow-rate operation M0 using the set IGV opening is applied on the high load side above the set value A1. Accordingly, the plant efficiency can be maintained at a desired value on the high load side.

Further, the present embodiment can be modified as follows.

### Modified Example 1

Since the possibility of occurrence of spontaneous combustion is higher when the fuel ratio of coal (fixed carbon / volatile part) is smaller than a predetermined value (for example, a fuel ratio of high grade coal) as is the case of low grade coal such as subbituminous coal, brown coal, or the like, an operation to switch the set air flow-rate operation M0 to the air flow-rate reduction operation M1 may be performed. The predetermined value of the fuel ratio is 0.7 to 1.2, for example.

The set air flow-rate operation M0 is selected by the controller when the fuel ratio is larger than the predetermined value as is the case of high grade coal, for example, and the air flow-rate reduction operation M1 is selected by the controller when the fuel ratio is smaller than the predetermined value as is the case of low grade coal, for example. Switching between the set air flow-rate operation M0 and the air flow-rate reduction operation M1 may be performed based on a measured value of a sensor that detects characteristics such as the fuel ratio of coal or may be performed manually by an operator. Alternatively, when the oxygen concentration measured by the oxygen concentration sensor 12a exceeds a predetermined value (13% by volume) during an operation of the IGCC 1, the set air flow-rate operation M0 may be switched to the air flow-rate reduction operation M1.

### Modified Example 2

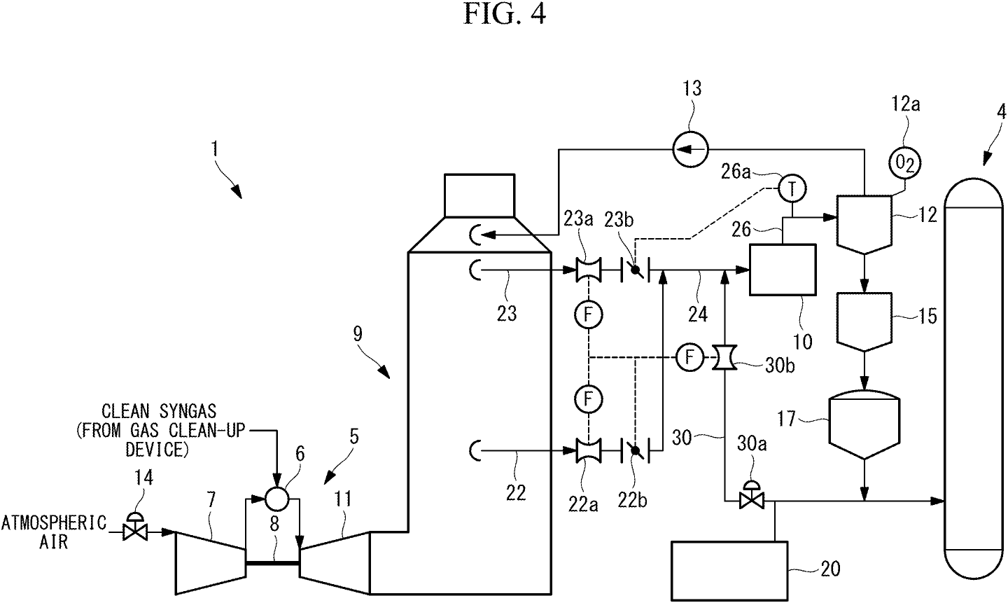

As illustrated in FIG. 4, nitrogen produced by the ASU (an oxygen concentration reduction unit) 20 may be supplied to the inlet side of the coal pulverizer 10. Specifically, a nitrogen supply channel 30 configured to supply nitrogen produced by the ASU 20 is connected to the merged flue gas extraction channel 24. A nitrogen valve 30a is provided to the nitrogen supply channel 30, and the opening of the nitrogen valve 30a is controlled by the controller with reference to the measured value of a flowmeter 30b.

This can reduce the oxygen concentration in the drying gas and thus reduce the possibility of spontaneous combustion of pulverized coal.

Note that the nitrogen supply channel 30 may be connected on the outlet side of the coal pulverizer 10 (upstream of the dust precipitator 12). This can reduce the possibility of spontaneous combustion in the dust precipitator 12, the bin 15, the hopper 17, or the like provided downstream of the coal pulverizer 10.

Further, the nitrogen valve 30a may be controlled so that the oxygen concentration measured by the oxygen concentration sensor 12a does not exceed a predetermined value (13% by volume).

### Modified Example 3

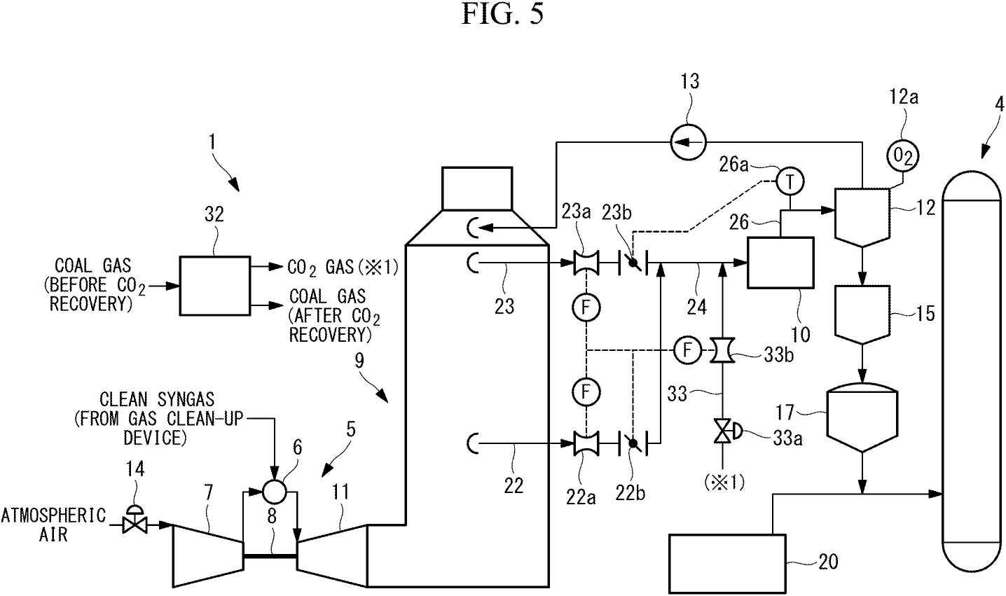

As illustrated in FIG. 5, a CO2 recovery device (the oxygen concentration reduction unit) 32 that is installed in the gas clean-up device and recovers CO2 from a coal gas (a raw syngas) guided from the gasifier 4 may be provided. In such a case, CO2 recovered by the CO2 recovery device 32 is supplied to the inlet side of the coal pulverizer 10. Specifically, a CO2 supply channel 33 configured to supply CO2 recovered by the CO2 recovery device 32 is connected to the merged flue gas extraction channel 24. A CO2 valve 33a is provided to the CO2 supply channel 33, and the opening of the CO2 valve 33a is controlled by the controller with reference to the measured value of a flowmeter 33b.

Accordingly, in addition to the air flow-rate reduction operation M1 by the IGV opening control, the oxygen concentration in the drying gas can be reduced, and the possibility of spontaneous combustion of pulverized coal can be reduced.

Note that the CO2 supply channel 33 may be connected on the outlet side of the coal pulverizer 10 (upstream of the dust precipitator 12). This can reduce the possibility of spontaneous combustion in the dust precipitator 12, the bin 15, the hopper 17, or the like provided downstream of the coal pulverizer 10.

Further, the CO2 valve 33a may be controlled so that the oxygen concentration measured by the oxygen concentration sensor 12a does not exceed a predetermined value (13% by volume).

### Modified Example 4

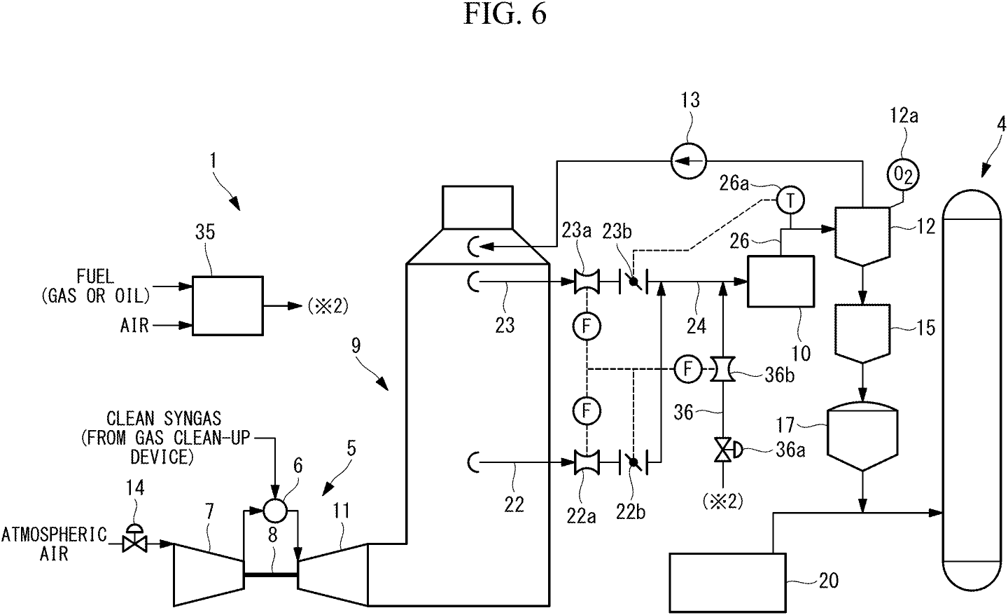

As illustrated in FIG. 6, a combustion device (the oxygen concentration reduction unit) 35 such as a burner of an auxiliary boiler may be provided. In such a case, a combustion gas generated by the combustion device 35 is supplied to the inlet side of the coal pulverizer 10. Specifically, a combustion gas supply channel 36 configured to supply the combustion gas generated by the combustion device 35 is connected to the merged flue gas extraction channel 24. A combustion gas valve 36a is provided to the combustion gas supply channel 36, and the opening of the combustion gas valve 36a is controlled by the controller with reference to the measured value of a flowmeter 36b.

Accordingly, in addition to the air flow-rate reduction operation M1 by the IGV opening control, the oxygen concentration in the drying gas can be reduced, and the possibility of spontaneous combustion of pulverized coal can be reduced.

Note that the combustion gas supply channel 36 may be connected on the outlet side of the coal pulverizer 10 (upstream of the temperature sensor 26a). This can reduce the possibility of spontaneous combustion in the dust precipitator 12, the bin 15, the hopper 17, or the like provided downstream of the coal pulverizer 10.

Further, the combustion gas valve 36a may be controlled so that the oxygen concentration measured by the oxygen concentration sensor 12a does not exceed a predetermined value (13% by volume).

### Modified Example 5

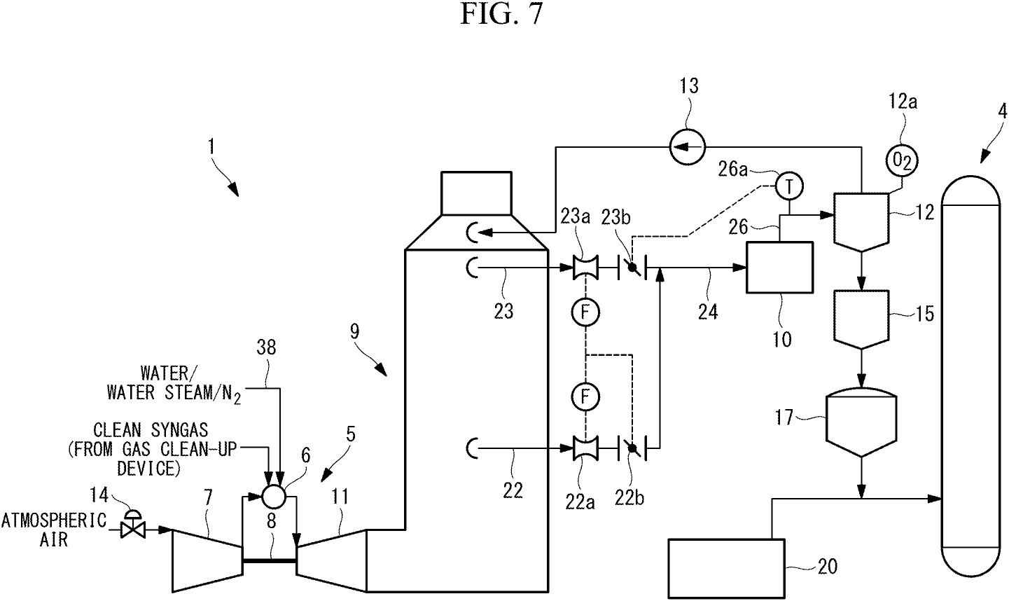

As illustrated in FIG. 7, an addition unit 38 that adds water, water steam, or nitrogen to the combustor 6 may be provided. By adding water, water steam, or nitrogen to the combustor 6, it is possible to reduce the oxygen concentration in the combustion gas. This can be performed in addition to the air flow-rate reduction operation M1 by the IGV opening control. This can reduce the possibility of spontaneous combustion of pulverized fuel. Note that a valve may be provided to the addition unit 38, and this value may be controlled.

Further, the addition amount of water, water steam, or nitrogen may be controlled so that the oxygen concentration measured by the oxygen concentration sensor 12a does not exceed a predetermined value (13% by volume).

### Modified Example 6

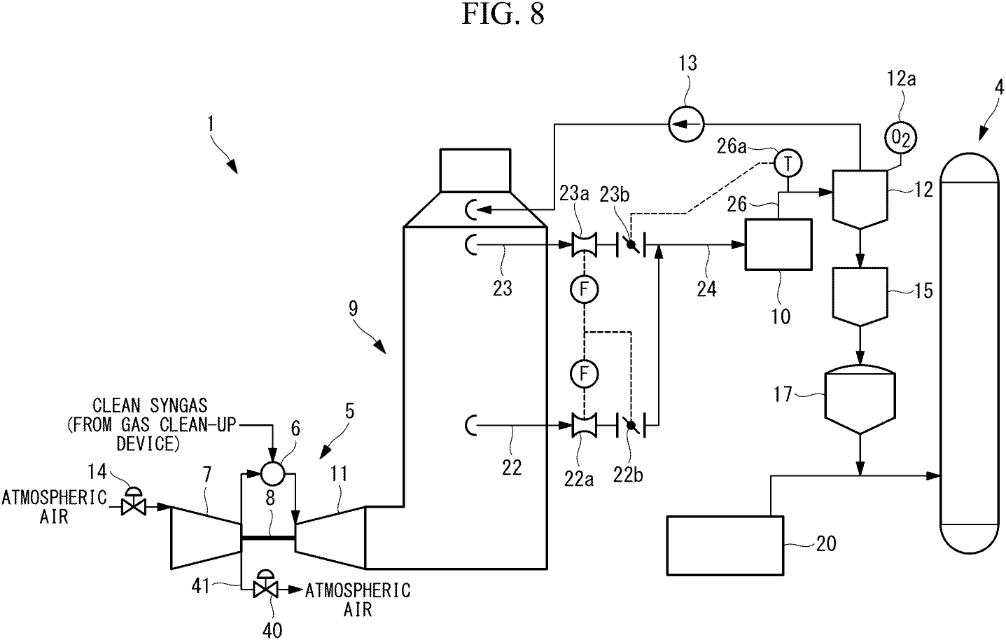

As illustrated in FIG. 8, a blow-off valve (a blow-off unit) 40 controlled by the controller may be provided on the outlet side of the compressor 7 as a unit that adjusts air to be supplied to the combustor 6. The blow-off valve 40 is provided to a blow-off channel (blow-off unit) 41 connected between the outlet of the compressor 7 and the inlet of the combustor 6. The downstream of the blow-off channel 41 is opened to the atmospheric air.

By opening the blow-off valve 40 to release a part of the compressed air, which is guided from the compressor 7 to the combustor 6, to the atmospheric air, it is possible to reduce the flow rate of air guided to the combustor 6. Accordingly, the air flow-rate reduction operation M1 described with reference to FIG. 2 and FIG. 3 can be applied. The control of the blow-off valve 40 can be used instead of the control of the IGV opening or in addition to the control of the IGV opening described with reference to FIG. 1.

### Modified Example 7

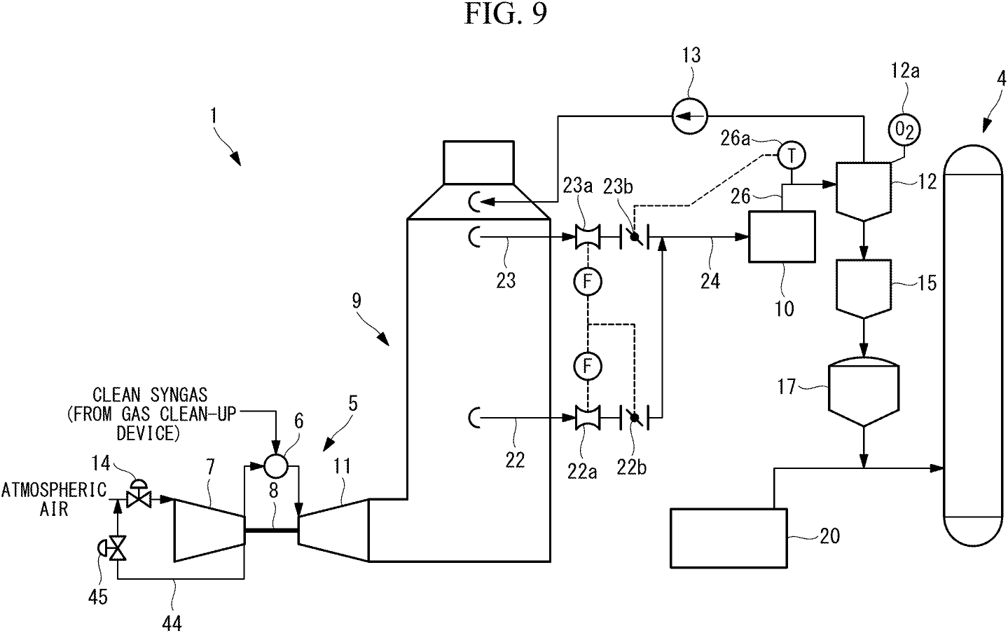

As illustrated in FIG. 9, a recirculation channel 44 connecting the outlet of the compressor 7 to the inlet of the compressor 7 may be provided as a unit that adjusts air to be supplied to the combustor 6. The downstream of the recirculation channel 44 is connected to the upstream of the IGV 14. The recirculation channel 44 is provided with a recirculation valve 45 controlled by the controller.

By opening the recirculation valve 45 to recirculate a part of discharged air from the compressor 7 and heating the air taken in the compressor 7 by the heated discharged air from the compressor 7 to reduce the density of the intake air, it is possible to reduce the flow rate of air guided to the combustor 6. Accordingly, the air flow-rate reduction operation M1 described with reference to FIG. 2 and FIG. 3 can be applied. The control of the recirculation valve 45 can be used instead of the control of the IGV opening described with reference to FIG. 1 or in addition to the control of the IGV opening.

### Modified Example 8

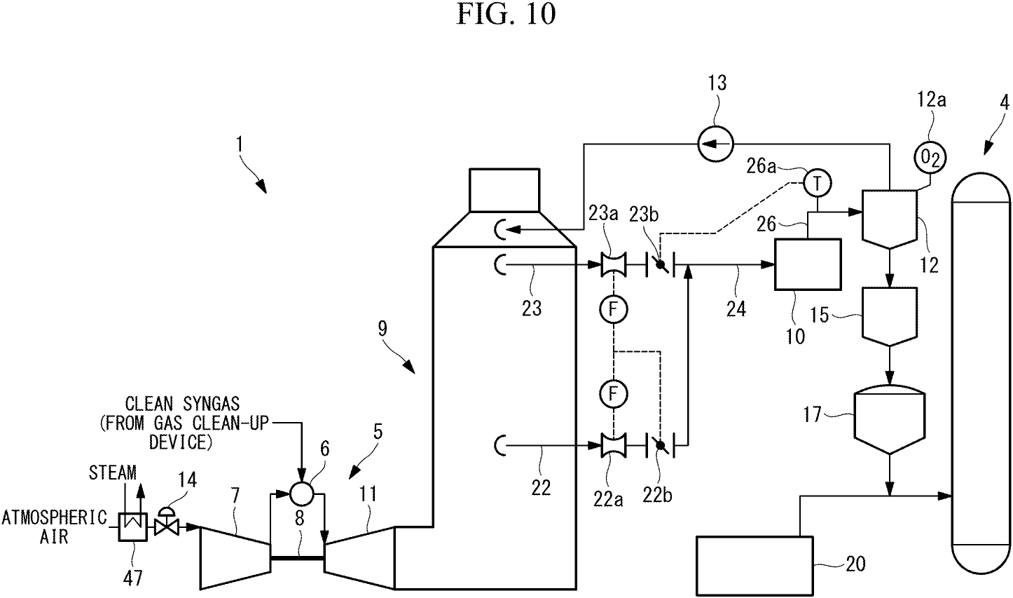

As illustrated in FIG. 10, a heat exchanger (a heating unit) 47 may be provided upstream of the IGV 14 as a unit that adjusts air to be supplied to the combustor 6. In the heat exchanger 47, heat is exchanged between steam and the atmospheric air (air). Accordingly, air taken in the compressor 7 is heated. As the steam, steam generated by the IGCC 1 or steam generated by an external auxiliary boiler or the like can be used. The controller controls the flow rate, the timing, or the like of the steam flowing into the heat exchanger 47 and thereby determines the timing of heating and the flow rate of air guided to the compressor 7.

By heating the air to be taken in the compressor 7 by using the heat exchanger 47 to reduce the density of the intake air, it is possible to reduce the flow rate of air guided to the combustor 6. Accordingly, the air flow-rate reduction operation M1 described with reference to FIG. 2 and FIG. 3 can be applied. The control of supplying steam to the heat exchanger 47 can be used instead of the control of the IGV opening described with reference to FIG. 1 or in addition to the control of the IGV opening. As the heating medium supplied to the heat exchanger 47, heated feedwater may be used instead of steam. A valve may be provided to a path through which steam (or feedwater) is supplied to the heat exchanger 47, and this valve may be controlled.

Note that, although illustration has been provided with coal as carbonaceous feedstock in the embodiment and the modified examples described above, biomass used as a renewable biological organic resource may be used, for example, thinned wood, waste timber, driftwood, grasses, waste, sludge, tires, recycle fuel (pellet or chip) made therefrom as feedstock, or the like may be used. Biomass or recycle fuel may be used together with coal.

The integrated gasification combined cycle and the operation method thereof according to each embodiment described above are understood as follows, for example.

An integrated gasification combined cycle (1) according to one aspect of the present disclosure includes: a pulverizer (10) configured to pulverize carbonaceous feedstock into pulverized fuel; a gasifier (4) configured to gasify pulverized fuel pulverized by the pulverizer; a combustor (6) configured to combust a gasified gas gasified by the gasifier; a compressor (7) configured to supply compressed air to the combustor; a gas turbine (5) driven by a combustion gas generated by the combustor; a generator driven by the gas turbine to generate power; a flue gas supply channel (22, 23, 24) configured to guide a part of a flue gas from the gas turbine to the pulverizer; a supply air flow-rate adjustment unit (14) configured to adjust a flow rate of air supplied from the compressor to the combustor; and a controller configured to apply an air flow-rate reduction operation to control the supply air flow-rate adjustment unit so that the flow rate of air is smaller than a set air flow rate calculated from a set combustion temperature of the combustor.

By reducing the flow rate of intake air supplied to the combustor, it is possible to reduce the oxygen concentration in the combustion gas. Accordingly, with an air flow rate smaller than a set air flow rate determined from a set combustion temperature of the combustor, the oxygen concentration is reduced to be lower than that at the setting. The combustion gas having the reduced oxygen concentration is guided to the pulverizer via the gas turbine and then through the flue gas supply channel. Accordingly, the possibility of spontaneous combustion of pulverized fuel pulverized by the pulverizer can be reduced without use of an auxiliary combustion burner.

Note that, in general, a set combustion temperature of a combustor is determined in accordance with a plant load of an integrated gasification combined cycle, more specifically, a load of a gas turbine. If a set combustion temperature is determined, an air flow rate required in the combustor is determined from the composition of a combustion gas such as a gasified clean syngas.

In the integrated gasification combined cycle (1) according to one aspect of the present disclosure, when a plant load of the integrated gasification combined cycle is a low load, the controller applies the air flow-rate reduction operation, and when the plant load exceeds the low load, the controller applies a set air flow-rate operation to control the supply air flow-rate adjustment unit so that the flow rate of air is the set air flow rate calculated from the set combustion temperature.

Since the oxygen concentration in the flue gas from the gas turbine tends to increase as the plant load decreases to a low load, it is preferable to apply the air flow-rate reduction operation when the plant load is the low load. In contrast, when the plant load exceeds the low load, it is possible to maintain the plant efficiency at a desired value by applying the set air flow-rate operation.

Note that the low load is 50% or less or 40% or less of the rated value. Further, the low load includes a load at startup of the integrated gasification combined cycle.

In the integrated gasification combined cycle (1) according to one aspect of the present disclosure, when carbonaceous feedstock having a fuel ratio smaller than a predetermined value is used, the controller selects the air flow-rate reduction operation.

When carbonaceous feedstock having a fuel ratio (fixed carbon/volatile part) smaller than a predetermined value is used, the possibility of occurrence of spontaneous combustion will be higher when pulverized fuel is used. Accordingly, when such carbonaceous feedstock having a fuel ratio smaller than the predetermined value is used, the air flow-rate reduction operation is selected. This can reduce the possibility of spontaneous combustion.

When carbonaceous feedstock having a fuel ratio larger than the predetermined value is used, the set air flow-rate operation may be applied without the air flow-rate reduction operation being applied.

The predetermined value of the fuel ratio is 0.7 to 1.2, for example.

In the integrated gasification combined cycle (1) according to one aspect of the present disclosure, the supply air flow-rate adjustment unit is an inlet guide vane (14) provided to the compressor.

By using an inlet guide vane (IGV) provided to the compressor as the supply air flow-rate adjustment unit, it is possible to reduce the flow rate of intake air during the air flow-rate reduction operation.

In the integrated gasification combined cycle (1) according to one aspect of the present disclosure, the supply air flow-rate adjustment unit includes a recirculation channel (44) connecting an outlet to an inlet of the compressor.

By providing the recirculation channel connecting the outlet to the inlet of the compressor to recirculate the discharged air, it is possible to reduce the flow rate of air guided to the combustor during the air flow-rate reduction operation.

In the integrated gasification combined cycle (1) according to one aspect of the present disclosure, the supply air flow-rate adjustment unit includes a heating unit (47) configured to heat air taken in the compressor.

By heating air taken in the compressor by using the heating unit to reduce the density of the intake air, it is possible to reduce the flow rate of air guided to the combustor during the air flow-rate reduction operation.

In the integrated gasification combined cycle (1) according to one aspect of the present disclosure, the supply air flow-rate adjustment unit includes a blow-off unit (40, 41) configured to externally release compressed air that is guided from the compressor to the combustor.

By externally releasing compressed air that is guided from the compressor to the combustor, it is possible to reduce the flow rate of air guided to the combustor during the air flow-rate reduction operation.

The integrated gasification combined cycle (1) according to one aspect of the present disclosure includes an oxygen concentration reduction unit (20) configured to reduce an oxygen concentration at an inlet or an outlet of the pulverizer.

By providing the oxygen concentration reduction unit configured to reduce the oxygen concentration at the inlet or the outlet of the pulverizer in addition to the air flow-rate reduction operation described above, it is possible to further reduce the possibility of spontaneous combustion of pulverized fuel.

The integrated gasification combined cycle (1) according to one aspect of the present disclosure includes an oxygen content meter (12a) provided on the outlet side of the pulverizer, and the controller controls the oxygen concentration reduction unit based on a measured value of the oxygen content meter.

By reducing the oxygen concentration based on a measured value of the oxygen content meter provided on the outlet side of the pulverizer, it is possible to more reliably reduce the possibility of spontaneous combustion of pulverized fuel.

The integrated gasification combined cycle (1) according to one aspect of the present disclosure includes an air separation unit (20), and the oxygen concentration reduction unit includes a nitrogen supply channel (30) configured to supply nitrogen generated by the air separation unit to the inlet or the outlet of the pulverizer.

By supplying nitrogen generated by the air separation unit (ASU) to the inlet or the outlet of the pulverizer, it is possible to reduce the oxygen concentration. This can reduce the possibility of spontaneous combustion of pulverized fuel. Note that, as nitrogen, a nitrogen gas whose primary component is nitrogen is used.

If nitrogen is supplied to the outlet of the pulverizer, it is possible to reduce the possibility of spontaneous combustion in a dust precipitator, a bin, a hopper, or the like provided downstream of the pulverizer.

The integrated gasification combined cycle (1) according to one aspect of the present disclosure includes a CO2 recovery device (32), and the oxygen concentration reduction unit includes a CO2 supply channel (33) configured to supply CO2 generated by the CO2 recovery device to the inlet or the outlet of the pulverizer.

By supplying CO2 generated by the CO2 recovery device to the inlet or the outlet of the pulverizer, it is possible to reduce the oxygen concentration. This can reduce the possibility of spontaneous combustion of pulverized fuel. Note that, as CO2, a CO2 gas whose primary component is CO2 is used.

If CO2 is supplied to the outlet of the pulverizer, it is possible to reduce the possibility of spontaneous combustion in a dust precipitator, a bin, a hopper, or the like provided downstream of the pulverizer.

The integrated gasification combined cycle (1) according to one aspect of the present disclosure includes a combustion device (35) configured to generate a combustion gas different from the combustion gas, and the oxygen concentration reduction unit includes a combustion gas supply channel (36) configured to supply the combustion gas generated by the combustion device to the inlet or the outlet of the pulverizer.

By supplying a combustion gas generated by the combustion device (a combustion gas that is different from the combustion gas generated by the combustor) to the inlet or the outlet of the pulverizer, it is possible to reduce the oxygen concentration. This can reduce the possibility of spontaneous combustion of pulverized fuel.

If the combustion gas is supplied to the outlet of the pulverizer, it is possible to reduce the possibility of spontaneous combustion in a dust precipitator, a bin, a hopper, or the like provided downstream of the pulverizer.

The combustion device may be, for example, a burner of an auxiliary boiler or the like.

In the integrated gasification combined cycle (1) according to one aspect of the present disclosure, the oxygen concentration reduction unit includes an addition unit (38) configured to add water and/or water steam and/or nitrogen to the combustor.

By adding water and/or water steam and/or nitrogen to the combustor, it is possible to reduce the oxygen concentration in the combustion gas. This can reduce the possibility of spontaneous combustion of pulverized fuel.

An operation method of an integrated gasification combined cycle (1) according to one aspect of the present disclosure is an operation method of an integrated gasification combined cycle including a pulverizer configured to pulverize carbonaceous feedstock into pulverized fuel, a gasifier configured to gasify pulverized fuel pulverized by the pulverizer, a combustor configured to combust a gasified gas gasified by the gasifier, a compressor configured to supply compressed air to the combustor, a gas turbine driven by a combustion gas generated by the combustor, a generator driven by the gas turbine to generate power, a flue gas supply channel configured to guide a part of a flue gas from the gas turbine to the pulverizer, and a supply air flow-rate adjustment unit configured to adjust a flow rate of air supplied from the compressor to the combustor, and the operation method includes applying an air flow-rate reduction operation to control the supply air flow-rate adjustment unit so that the flow rate of air is smaller than a set air flow rate calculated from a set combustion temperature of the combustor.

REFERENCE SIGNS LIST

| | |
|---|---|
| 1 | integrated gasification combined cycle (IGCC) |
| 4 | gasifier |
| 5 | gas turbine |
| 6 | combustor |
| 7 | compressor |
| 9 | heat recovery steam generator |
| 10 | coal pulverizer (pulverizer) |
| 12 a | oxygen concentration sensor |
| 14 | IGV (supply air flow-rate adjustment unit) |
| 20 | air separation unit (ASU) |
| 22 | high-temperature flue gas extraction channel (flue gas supply channel) |
| 23 | low-temperature flue gas extraction channel (flue gas supply channel) |
| 24 | merged flue gas extraction channel (flue gas supply channel) |
| 30 | nitrogen supply channel |
| 32 | CO2 recovery device (oxygen concentration reduction unit) |
| 33 | CO2 supply channel |
| 35 | combustion device (oxygen concentration reduction unit) |
| 38 | addition unit |
| 40 | blow-off valve (blow-off unit) |
| 41 | blow-off channel (blow-off unit) |
| 44 | recirculation channel |
| 47 | heat exchanger (heating unit) |

1. An integrated gasification combined cycle comprising:
a pulverizer configured to pulverize carbonaceous feedstock into pulverized fuel;
a gasifier configured to gasify pulverized fuel pulverized by the pulverizer;
a combustor configured to combust a gasified gas gasified by the gasifier;
a compressor configured to supply compressed air to the combustor;
a gas turbine driven by a combustion gas generated by the combustor;
a generator driven by the gas turbine to generate power;
a flue gas supply channel configured to guide a part of a flue gas from the gas turbine to the pulverizer;
a supply air flow-rate adjustment unit configured to adjust a flow rate of air supplied from the compressor to the combustor; and
a controller configured to apply an air flow-rate reduction operation to control the supply air flow-rate adjustment unit so that the flow rate of air is smaller than a set air flow rate calculated from a set combustion temperature of the combustor.

2. The integrated gasification combined cycle according to claim 1, wherein when a plant load of the integrated gasification combined cycle is a low load, the controller applies the air flow-rate reduction operation, and when the plant load exceeds the low load, the controller applies a set air flow-rate operation to control the supply air flow-rate adjustment unit so that the flow rate of air is the set air flow rate calculated from the set combustion temperature.

3. The integrated gasification combined cycle according to claim 1, wherein when carbonaceous feedstock having a fuel ratio smaller than a predetermined value is used, the controller selects the air flow-rate reduction operation.

4. The integrated gasification combined cycle according to claim 1,wherein the supply air flow-rate adjustment unit is an inlet guide vane provided to the compressor.

5. The integrated gasification combined cycle according to claim 1, wherein the supply air flow-rate adjustment unit comprises a recirculation channel connecting an outlet to an inlet of the compressor.

6. The integrated gasification combined cycle according to claim 1, wherein the supply air flow-rate adjustment unit comprises a heating unit configured to heat air taken in the compressor.

7. The integrated gasification combined cycle according to claim 1, wherein the supply air flow-rate adjustment unit comprises a blow-off unit configured to externally release compressed air guided from the compressor to the combustor.

8. The integrated gasification combined cycle according to claim 1 further comprising an oxygen concentration reduction unit configured to reduce an oxygen concentration at an inlet or an outlet of the pulverizer.

9. The integrated gasification combined cycle according to claim 8 further comprising an oxygen content meter provided on the outlet side of the pulverizer,
wherein the controller controls the oxygen concentration reduction unit based on a measured value of the oxygen content meter.

10. The integrated gasification combined cycle according to claim 8 further comprising an air separation unit,
wherein the oxygen concentration reduction unit comprises a nitrogen supply channel configured to supply nitrogen generated by the air separation unit to the inlet or the outlet of the pulverizer.

11. The integrated gasification combined cycle according to claim 8 further comprising a CO2 recovery device,
wherein the oxygen concentration reduction unit comprises a CO2 supply channel configured to supply CO2 generated by the CO2 recovery device to the inlet or the outlet of the pulverizer.

12. The integrated gasification combined cycle according to claim 8 further comprising a combustion device configured to generate a combustion gas different from the combustion gas,
wherein the oxygen concentration reduction unit comprises a combustion gas supply channel configured to supply the combustion gas generated by the combustion device to the inlet of the outlet of the pulverizer.

13. The integrated gasification combined cycle according to claim 8, wherein the oxygen concentration reduction unit comprises an addition unit configured to add water and/or water steam and/or nitrogen to the combustor.

14. An operation method of an integrated gasification combined cycle, wherein the integrated gasification combined cycle comprises
a pulverizer configured to pulverize carbonaceous feedstock into pulverized fuel,
a gasifier configured to gasify pulverized fuel pulverized by the pulverizer,
a combustor configured to combust a gasified gas gasified by the gasifier,
a compressor configured to supply compressed air to the combustor,
a gas turbine driven by a combustion gas generated by the combustor,
a generator driven by the gas turbine to generate power,
a flue gas supply channel configured to guide a part of a flue gas from the gas turbine to the pulverizer, and
a supply air flow-rate adjustment unit configured to adjust a flow rate of air supplied from the compressor to the combustor,
the operation method comprising:
applying an air flow-rate reduction operation to control the supply air flow-rate adjustment unit so that the flow rate of air is smaller than a set air flow rate calculated from a set combustion temperature of the combustor.
